(19) United States
(12) Patent Application Publication
(10) Pub. No.: US 2016/0037107 A1
(43) Pub. Date: Feb. 4, 2016

(54) IMAGING DEVICE, IMAGING APPARATUS, AND IMAGING SYSTEM

(71) Applicant: CANON KABUSHIKI KAISHA, Tokyo (JP)

(72) Inventor: Kiyofumi Sakaguchi, Miura-gun (JP)

(21) Appl. No.: 14/811,477

(22) Filed: Jul. 28, 2015

(30) Foreign Application Priority Data
Jul. 31, 2014 (JP) 2014-156788

(51) Int. Cl. H04N 5/369

(52) U.S. Cl. CPC H04N 5/3698

(57) ABSTRACT

An imaging device includes a substrate, a plurality of pixel electrodes, a conductive line that is disposed between the substrate and the plurality of pixel electrodes, a common electrode portion facing the plurality of pixel electrodes, a plurality of photoelectric conversion portions each of which is disposed between a corresponding one of the plurality of pixel electrodes and the common electrode portion, and a pad portion that is used for supplying an electric potential to the common electrode portion from the outside. The pad portion includes an electroconductive film that is included in the common electrode portion.

### BACKGROUND OF THE INVENTION

1. Field of the Invention

The present invention relates to a pad of an imaging device.

2. Description of the Related Art

There is known a thin film-type imaging apparatus in which a photoelectric-conversion film is formed on a semiconductor substrate, in which a pixel circuit is formed, with an insulating film interposed between the photoelectric-conversion film and the semiconductor substrate. In such a thin film-type imaging apparatus, a material having a large optical absorption coefficient, such as amorphous silicon or an organic material, can be used as the photoelectric-conversion film, and such a thin film-type imaging apparatus can have a higher sensitivity than CCD-type and CMOS-type imaging apparatuses of the related art.

An electrode is required to be provided on opposite sides of a photoelectric-conversion film in order to read signals from the photoelectric-conversion film. In particular, in an imaging region, an upper electrode formed on the photoelectric-conversion film often serves as a common electrode portion, and an electric potential that is common to all pixels is often applied to the upper electrode.

Japanese Patent Laid-Open No. 2012-114197 describes that an upper electrode (44) extending over a peripheral region (130) is in contact with a conductive line (37a), which is exposed through an opening (40a), so that the upper electrode (44) and the conductive line (37a) are electrically connected to each other. A surface of the upper electrode (44) facing a lower electrode (41) is in contact with the conductive line (37a). In addition, a voltage supply portion (160) of an upper electrode (44a) is electrically connected to a bonding pad (39) disposed in a pad region (140) so that a voltage is applied to the upper electrode (44a) disposed in a pixel region (115).

As described in Japanese Patent Laid-Open No. 2012-114197, in the case where a voltage is applied to the upper electrode (44a) via the bonding pad (39) and the conductive line (37a), which is in contact with the surface of the upper electrode (44a) facing the lower electrode (41), a supply path through which an electric potential is supplied to a common electrode portion from the outside becomes complex. In addition, as a result of an increase in the resistance of the complex supply path or as a result of occurrence of disconnection in the complex supply path, there is a possibility that the reliability of the imaging apparatus will decrease.

The present invention is intended to simplify a supply path through which an electric potential is supplied to a common electrode portion from the outside.

### SUMMARY OF THE INVENTION

An imaging device according to aspects of the present invention includes a substrate, a plurality of pixel electrodes, a conductive line disposed between the substrate and the plurality of pixel electrodes, a common electrode portion facing the plurality of pixel electrodes, a plurality of photoelectric conversion portions each of which is disposed between a corresponding one of the plurality of pixel electrodes and the common electrode portion, and a pad portion that is used for supplying an electric potential to the common electrode portion from outside.

In an imaging device according to a first aspect of the present invention, the pad portion includes an electroconductive film that is included in the common electrode portion.

In an imaging device according to a second aspect of the present invention, the pad portion includes a first electroconductive film that is different from a second electroconductive film, which is included in the common electrode portion, and the first electroconductive film is in contact with a surface of the second electroconductive film on a side opposite to the pixel electrodes.

Further features of the present invention will become apparent from the following description of exemplary embodiments with reference to the attached drawings.

### BRIEF DESCRIPTION OF THE DRAWINGS

FIGS. 1A to 1C are schematic diagrams illustrating an example of an imaging device.

FIGS. 2A to 2C are schematic diagrams illustrating another example of the imaging device.

FIGS. 3A to 3C are schematic diagrams illustrating another example of the imaging device.

FIG. 4 is a schematic diagram illustrating the example of the imaging device illustrated in FIG. 1.

FIGS. 5A to 5D are schematic diagrams illustrating an example of an imaging apparatus.

### DESCRIPTION OF THE EMBODIMENTS

Embodiments of the present invention will be described below with reference to the drawings. Note that, in the following description and the drawings, when the same components are illustrated in multiple drawings, they are denoted by the same reference numerals. The components, which are common through the multiple drawings, will be described with cross-reference to the drawings, and repeated descriptions will be omitted.

### First Embodiment

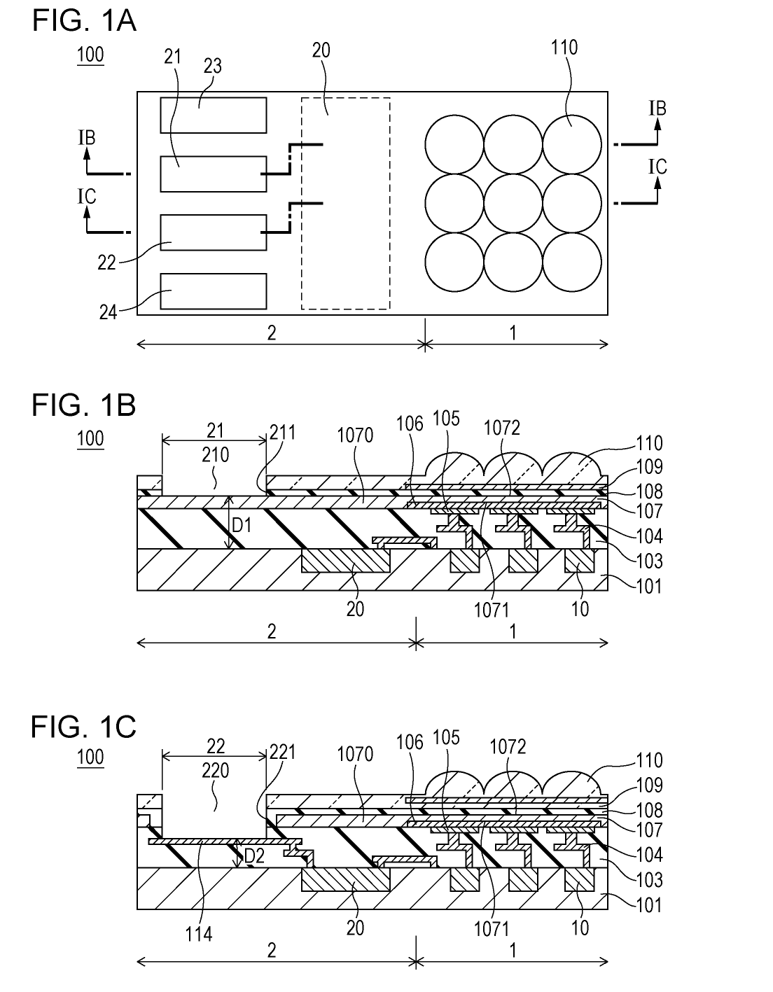

An imaging device according to a first embodiment will now be described. FIG. 1A is a schematic plan view of an imaging device 100, FIG. 1B is a schematic sectional view of the imaging device 100 taken along line IB-IB of FIG. 1A, and FIG. 1C is a schematic sectional view of the imaging device 100 taken along line IC-IC of FIG. 1A.

The imaging device 100 includes an imaging region 1 and a peripheral region 2, which is located outside the imaging region 1. In the imaging region 1, a plurality of pixel electrodes 105 and a common electrode portion 107 facing the plurality of pixel electrodes 105 are disposed. An electroconductive film 1070 that is included in the common electrode portion 107 has a bottom surface 1071, which is a surface facing the pixel electrodes 105, and a top surface 1072, which is a surface on the side opposite to the pixel electrodes 105. In addition, in the imaging region 1, a plurality of photoelectric-conversion portions arranged between the plurality of pixel electrodes 105 and the common electrode portion 107 are disposed. The plurality of photoelectric-conversion portions are at least portions of a photoelectric-conversion film 106 continuously covering the plurality of pixel electrodes 105, the at least portions being positioned between the common electrode portion 107 and the pixel electrodes 105. The plurality of pixel electrodes 105 are arranged two-dimensionally or one-dimensionally. An insulating film 103 is disposed on a semiconductor substrate 101, and the plurality of pixel electrodes 105, the photoelectric-conversion film 106, and the common electrode portion 107 are disposed on the insulating film 103. Furthermore, in the imaging region 1, a plurality of pixel circuit units 10 for reading electric carriers generated by the photoelectric-conversion portions are disposed. A plurality of transistors (not illustrated), which are included in the pixel circuit units 10, are disposed on a main surface of the semiconductor substrate 101. Conductive lines 104 are formed within the insulating film 103. The insulating film 103 is a multilayer film formed of a plurality of insulating films, and each of the conductive lines 104 may be a multilayer wiring constituted by wiring layers, which are stacked on top of one another with vias interposed therebetween. The plurality of transistors, which are disposed on the semiconductor substrate 101, are electrically connected to the pixel electrodes 105 via the conductive lines 104.

In the imaging region 1, an insulating film 108 that functions as a protective film (passivation film) is formed on the common electrode portion 107 on the side opposite to the pixel electrodes 105. The insulating film 108 may be, for example, a single layer film including any one of a silicon nitride layer, a silicon oxynitride layer, and a silicon oxide layer or a multilayer film including any one or more of a silicon nitride layer, a silicon oxynitride layer, and a silicon oxide layer. A color filter 109 and a microlens 110 are disposed on the insulating film 108. A planarizing film may be formed between the color filter 109 and the microlens 110.

In the peripheral region 2, a peripheral circuit unit 20, and pad portions 21, 22, 23, and 24 are disposed. The peripheral circuit unit 20 may include at least one of a driving circuit that drives the pixel circuit units 10, a signal processing circuit that processes signals obtained by the pixel circuit units 10, and a control circuit that controls the driving circuit and the signal processing circuit. The pad portion 21 is provided for supplying an electric potential to the common electrode portion 107 from the outside. A surface of the pad portion 21 is formed of an electroconductive film, and a conductive member provided for connecting the imaging device 100 and an external circuit to each other is in contact with the surface of the pad portion 21. The pad portion 22 is provided for outputting a signal from the imaging device 100 to the outside. The signal to be output by the imaging device 100 to the outside is generated by, for example, the signal processing circuit of the peripheral circuit unit 20. The pad portion 23 is provided for inputting signals to the imaging device 100 from the outside. The signals to be input into the imaging device 100 from the outside are control signals and reference signals. The pad portion 24 is provided for supplying a power supply voltage to the imaging device 100 from the outside. Surfaces of the pad portions 21 to 24 are exposure surfaces that are exposed to the external atmosphere before conductive members, which are provided for connecting the imaging device 100 and the external circuit to each other, are brought into contact with the surfaces. In addition, the surfaces of the pad portions 21 to 24 are contact surfaces with which the corresponding conductive members, which are provided for connecting the imaging device 100 and the external circuit to each other, are brought into contact.

The area of the pad portion 21 is represented by an arrow in FIG. 1B, and the area of the pad portion 22 is represented by an arrow in FIG. 1C. The pad portions 23 and 24 each have a configuration similar to that of the pad portion 22. The pad portion 21 includes at least a portion of an electroconductive film that is included in the pad portion 21, and the pad portion 22 includes at least a portion of an electroconductive film that is included in the pad portion 22. In the pad portion 21, an electroconductive film having a contact surface in contact with the corresponding conductive member is the electroconductive film that is included in the pad portion 21. In the pad portion 22, an electroconductive film having a contact surface in contact with the corresponding conductive member is the electroconductive film that is included in the pad portion 22.

The electroconductive film included in the pad portion 21 and the electroconductive film included in the pad portion 22 may have, in their surface, a contact region in contact with the corresponding conductive member, which is provided for connecting the imaging device 100 and the external circuit to each other. The pad portion 21 includes a portion that is at least a portion of the electroconductive film included in the pad portion 21 and that is located in an orthogonally-projected area of the contact region, and the pad portion 22 includes a portion that is at least a portion of the electroconductive film included in the pad portion 22 and that is located in an orthogonally-projected area of the contact region. In each of the pad portions 21 and 22, the portion located in the orthogonally-projected area of the contact region is a portion of the electroconductive film included in the pad portion 21 or the pad portion 22, the portion being superposed with the corresponding contact region in a direction perpendicular to a main surface (front surface or rear surface) of the electroconductive film.

The electroconductive film included in the pad portion 21 and the electroconductive film included in the pad portion 22 may have, in their surface, an exposed region that is exposed to the external atmosphere in order to connect the imaging device 100 and the external circuit to each other. The pad portion 21 includes a portion that is at least a portion of the electroconductive film included in the pad portion 21 and that is located in an orthogonally-projected area of the exposed region, and the pad portion 22 includes a portion that is at least a portion of the electroconductive film included in the pad portion 22 and that is located in an orthogonally-projected area of the exposed region. In each of the pad portions 21 and 22, the portion located in the orthogonally-projected area of the exposed region is a portion of the electroconductive films included in the pad portion 21 or the pad portion 22, the portion being superposed with the corresponding exposed region in a direction perpendicular to main surfaces (front surfaces and rear surfaces) of the electroconductive film.

The electroconductive film included in the pad portion 21 and the electroconductive film included in the pad portion 22 may have a covered region that is covered with an insulating film in such a manner as to be protected against the external atmosphere. In each of the pad portions 21 and 22, a boundary between the exposed region and the covered region is defined by the insulating film, which covers the covered region. The pad portion 21 does not include a portion that is a portion of the electroconductive film included in the pad portion 21 and that is located in an orthogonally-projected area of the covered region, and the pad portion 22 does not include a portion that is a portion of the electroconductive film included in the pad portion 22 and that is located in an orthogonally-projected area of the covered region. In each of the pad portions 21 and 22, the portion located in the orthogonally-projected area of the covered region is a portion of the electroconductive films included in the pad portion 21 or the pad portion 22, the portion being superposed with the corresponding covered region in the direction perpendicular to the main surfaces (front surfaces and rear surfaces) of the electroconductive film.

Electroconductive films that are in contact with the above described electroconductive films each having the exposed region and/or the contact region and each of which includes a portion located in an orthogonally-projected area of the corresponding exposed region and/or the corresponding contact region may also be the electroconductive films included in the pad portion 21 and the pad portion 22. Each of the pad portions 21 and 22 includes a portion of an electroconductive film that is different from the electroconductive film having the exposed region and/or the contact region and that is in contact with the electroconductive film having the exposed region and/or the contact region, the portion being located in an orthogonally-projected area of the exposed region and/or the contact region. An electroconductive film that includes a portion located in an orthogonally-projected area of the exposed region and/or the contact region and that is not in contact with the electroconductive film having the exposed region and/or the contact region is not either of the electroconductive film included in the pad portion 21 and the electroconductive film included in the pad portion 22. For example, an electroconductive film that is superposed with the exposed region or the contact region with an insulating film interposed therebetween and that is not in contact with the electroconductive film having the exposed region and/or the contact region is not either of the electroconductive film included in the pad portion 21 and the electroconductive film included in the pad portion 22.

The electroconductive film included in the pad portion 21 and the electroconductive film included in the pad portion 22 may each be a multilayer film or a single layer film. An electroconductive film that is a multilayer film includes a plurality of conductive layers each having substantially the same planar shape (pattern). More specifically, an electroconductive film that is a multilayer film includes a group of conductive layers that are patterned by using a single mask in such a manner that their side surfaces are continuous with one another and their top surfaces and/or bottom surfaces are in contact with one another. Conductive layers having different planar shapes belong not to a single electroconductive film, but to different electroconductive films.

In the first embodiment, the electroconductive film 1070, which is included in the common electrode portion 107, extends from the imaging region 1 to the peripheral region 2, and the pad portion 21 includes the electroconductive film 1070, which is included in the common electrode portion 107. More specifically, a surface of the pad portion 21 is formed in the top surface 1072 of the common electrode portion 107, which is a surface on the side opposite to the pixel electrodes 105. In the case where the material of the common electrode portion 107 is a light-transmitting electroconductive material, the pad portion 21 is made of a light-transmitting electroconductive material. In particular, by using a metal oxide, such as indium tin oxide (ITO), which is known as a light-transmitting electroconductive material, for the surface of the pad portion 21, deterioration of the surface of the pad portion 21 due to natural oxidation can be suppressed. The insulating film 108 extends from the imaging region 1 to the peripheral region 2 and has an opening 210 that defines the pad portion 21. One of the above-described conductive members is in contact with the common electrode portion 107 via the opening 210. A side surface 211 of the opening 210 is located above the electroconductive film 1070, which is included in the common electrode portion 107.

In the imaging device 100 that includes the pad portion 21, which has such a configuration, it is not necessary to form an electric path, through which an electric potential is supplied to the common electrode portion 107 from the pad portion 21, in the conductive lines 104. Thus, a supply path through which an electric potential is supplied to the common electrode portion 107 from the outside can be simplified, and the probability of the occurrence of a problem related to reliability in the supply path, through which an electric potential is supplied to the common electrode portion 107 from the outside, can be reduced. In addition, since it is not necessary to route an extra conductive line, the degree of freedom when arranging conductive lines increases, and for example, the thickness of other conductive lines can be increased. Furthermore, since the conductive members, which are provided for connecting the imaging device 100 and the external circuit to each other, can be directly in contact with the electroconductive film 1070, which is included in the common electrode portion 107, an increase in the contact resistance can be suppressed, and the probability of the occurrence of contact failure can be reduced.

A surface of the pad portion 22 is formed of an electroconductive film 114, which is a portion of the conductive lines 104. The material of the electroconductive film 114 may be, for example, a metal, such as Al, Ti, TiN, Cu, Ta, TaN, Cr, or W, or a metal nitride. For example, the electroconductive film 114 is a multilayer film formed of an Al layer, a TiN layer, and/or a Ti layer, and the surface of the pad portion 22 is formed of a TiN layer. In the first embodiment, the material of the electroconductive film 114, which is included in the pad portion 22, is different from the material of the common electrode portion 107. The insulating film 108 extends from the imaging region 1 to the peripheral region 2 and has an opening 220 that defines the pad portion 22. One of the above-described conductive members is in contact with the electroconductive film 114 via the opening 220. A side surface 221 of the opening 220 is located above the electroconductive film 114.

A distance D1 from the surface of the pad portion 21 to the main surface of the semiconductor substrate 101 is larger than a distance D2 from the surface of the pad portion 22 to the main surface of the semiconductor substrate 101. This is because the surface of the pad portion 21 is formed of the electroconductive film 1070, which is included in the common electrode portion 107 positioned above the photoelectric conversion film 106 (on the side opposite to the semiconductor substrate 101), and the surface of the pad portion 22 is positioned below the photoelectric conversion film 106 (on the side on which the semiconductor substrate 101 is disposed).

Similar to the pad portion 22, the surface of each of the pad portions 23 and 24 is formed of an electroconductive film, which is included in the conductive lines 104. The pad portions 23 and 24 are disposed in such a manner that the distance from the surface of the pad portion 23 to the semiconductor substrate 101 and the distance from the surface of the pad portion 24 to the semiconductor substrate 101 are smaller than the distance D1.

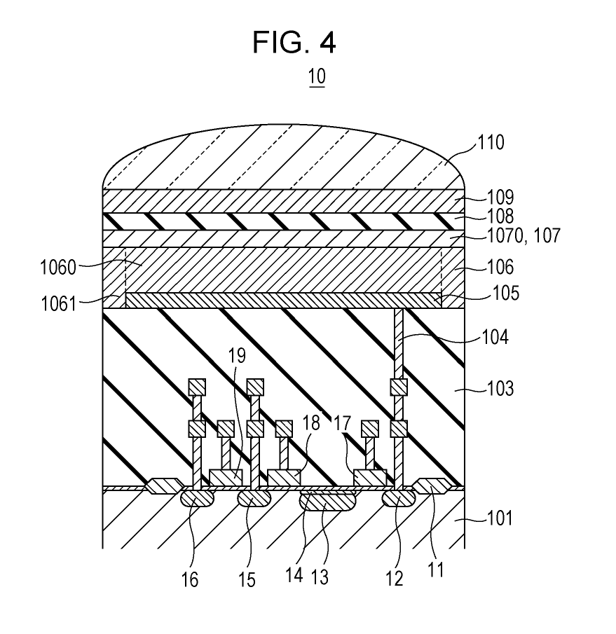

FIG. 4 is a sectional view illustrating an example of the structure of pixels in the imaging region 1. Pixel circuits that are provided for the pixels are separated from one another by device-separation portions 11. An n-type impurity region 12 that is formed in the semiconductor substrate 101 is connected to one of the pixel electrodes 105 via one of the conductive lines 104. Electric carriers in the n-type impurity region 12 are transferred to an n-type impurity region 13 via a transfer gate 17. A p-type impurity region 14 is formed between the n-type impurity region 13 and the surface of the semiconductor substrate 101, and accordingly, a buried-type electric-carrier-accumulating portion CS is formed. By employing such a buried-type electric-carrier-accumulating portion CS, the probability that a dark current generated on the surface of the semiconductor substrate 101 will be mixed into the electric-carrier-accumulating portion CS can be reduced, and the signal-to-noise (S/N) ratio is improved. Electric carriers in the n-type impurity region 13 are transferred to an n-type impurity region 15 via a transfer gate 18. The electric-carrier-accumulating portion CS can be fully depleted by adjusting the impurity concentration, and full transfer of the electric-carrier-accumulating portion CS from the n-type impurity region 13 to the n-type impurity region 15 can be achieved. The n-type impurity region 15 forms a floating node FN and is connected to a signal output unit (not illustrated). The signal output unit may be, for example, a source follower circuit. The n-type impurity region 15 is reset to have an electric potential corresponding to the electric potential of an n-type impurity region 16 by turning on a reset gate 19.

The photoelectric conversion film 106, which is a continuous film, may include boundary portions 1061 between a plurality of photoelectric conversion portions 1060. The boundary portions 1061 are portions of the photoelectric conversion film 106 that are not superposed with the pixel electrodes 105. Some oblique incident light may sometimes be photoelectrically converted by the boundary portions 1061. At least portions of the boundary portions 1061 may be omitted, and the photoelectric conversion portions 1060 may be provided not as portions of a continuous film, but as a plurality of isolated patterns. Alternatively, a metal-insulator-semiconductor (MIS) structure in which a thin insulating film having a thickness of, for example, less than 100 nm is provided between the photoelectric conversion portions 1060 and the pixel electrodes 105 may be employed.

The photoelectric conversion film 106 may have a P-I-N structure or may be a film including quantum dots (a quantum dot film). Amorphous silicon, a compound semiconductor, or an organic semiconductor can be used. The compound semiconductor is, for example, a III-V compound semiconductor, such as BN, GaAs, GaP, AlSb, or GaAlAsP, a II-VI compound semiconductor, such as CdSe, ZnS, or HdTe, or a IV-VI compound semiconductor, such as PbS, PbTe, or CuO. The organic semiconductor is, for example, fullerene, coumarin 6 (C6), rhodamine 6G (R6G), zinc phthalocyanine (ZnPc), quinacridon, a phthalocyanine-based compound, a naphthalocyanine-based compound, or the like. In particular, an amorphous silicon film, an organic semiconductor film, and a quantum dot film that can be easily formed as a thin film having a thickness of less than 1 μm are preferable. In addition, a quantum dot film that is sufficiently compensated for an interface defect is further preferable because such a quantum dot film can be fully depleted easily. Although it is preferable that the photoelectric conversion film 106 be an intrinsic semiconductor (I-type semiconductor) having a low carrier density in order to sufficiently increase the width of a depletion layer, an N-type semiconductor, a P-type semiconductor, or the like that has a low impurity concentration can be used.

The electroconductive film 1070, which is included in the common electrode portion 107, has a sufficiently high light transmittance for light detected by the photoelectric conversion film 106. For example, in the case where the photoelectric conversion film 106 is exposed to visible light, the electroconductive film 1070 is made of a light-transmitting electroconductive material, such as ITO, that allows the visible light to pass through. The photoelectric conversion film 106 and the electroconductive film 1070 may each be a multilayer film or may each be a single layer film.

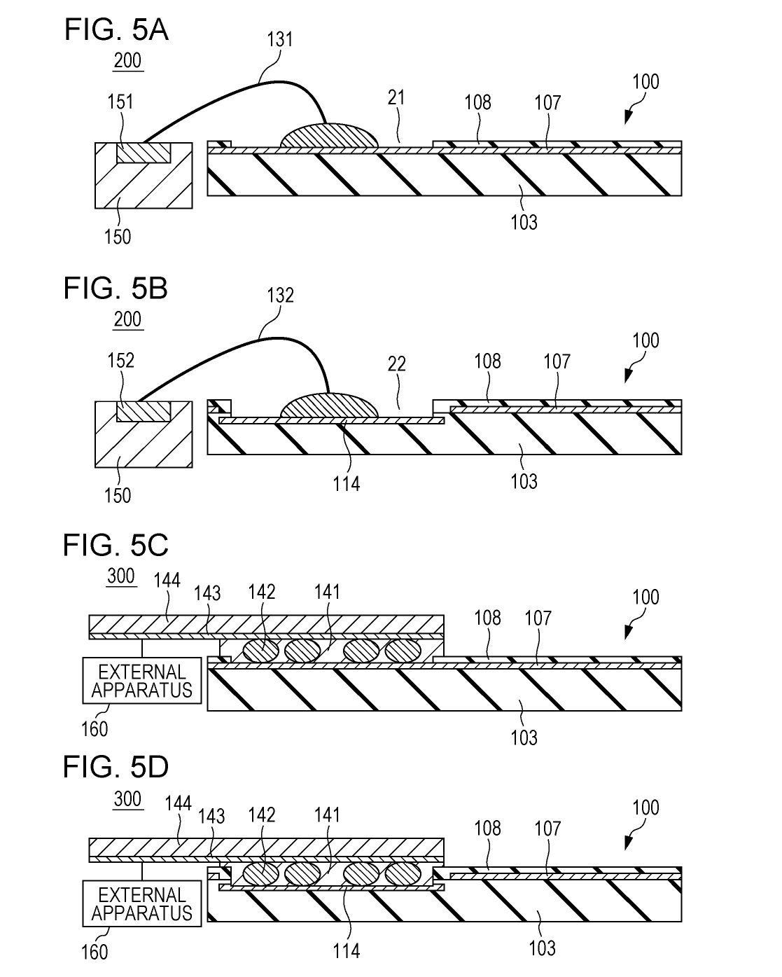

FIG. 5A is an enlarged sectional view illustrating the pad portion 21 and the peripheral portion of an imaging apparatus 200 that includes the imaging device 100 in a first example of an imaging apparatus, and FIG. 5B is an enlarged sectional view illustrating the pad portion 22 and the peripheral portion of the imaging apparatus 200 that includes the imaging device 100 in the first example of the imaging apparatus. The imaging apparatus 200 includes packages 150 and conductive members 131 and 132 that are respectively in contact with the surface of the pad portion 21 and the surface of the pad portion 22 in such a manner as to connect terminals 151 and 152, which are disposed in a corresponding one of the packages 150, and the imaging device 100 to each other. In the first example, the conductive members 131 and 132 are bonding wires that are respectively in contact with the pad portions 21 and 22 by wire bonding. Since the distance from the semiconductor substrate 101 to the pad portion 21 and the distance from the semiconductor substrate 101 to the pad portion 22 are different from each other, it is preferable that the wire bonding be performed on the pad portion 21 and the pad portion 22 under different bonding conditions.

FIG. 5C is an enlarged sectional view illustrating the pad portion 21 and the peripheral portion of the imaging apparatus 300, which includes the imaging device 100 in a second example of an imaging apparatus, and FIG. 5D is an enlarged sectional view illustrating the pad portion 22 and the peripheral portion of the imaging apparatus 300, which includes the imaging device 100 in the second example of the imaging apparatus. The imaging apparatus 300 includes a wiring member 144, such as a flexible printed circuit board or a rigid printed circuit board, and conductive members each of which is in contact with one of the surfaces of the pad portions 21 and 22 in such a manner as to connect a terminal 143, which is disposed on the wiring member 144, and the imaging device 100 to each other. Each of the conductive members in the second example is an anisotropic conductive film (ACF) 141 containing conductive particles 142. Instead of the ACF 141, a member formed by curing an anisotropic conductive paste may be used as each of the conductive members.

Although the distance from the surface of the semiconductor substrate 101 to the pad portion 21 and the distance from the surface of the semiconductor substrate 101 to the pad portion 22 are different from each other, if the distance difference is less than 10 μm, the pad portion 21 and the pad portion 22 can be easily connected to each other even in the case where the ACF 141 is used.

An imaging system 300 can be constructed by using the imaging device 100. The imaging system 300 is a camera or an information terminal that has an image-capturing function. The imaging system 300 may include an external apparatus 160 that includes a signal processing circuit that processes signals obtained from the imaging device 100, a display that displays an image captured by the imaging device 100, and the like. In the imaging system 300, the imaging device 100 is mounted on a circuit substrate with solder or the like by a package and is electrically connected to the external apparatus 160.

### Second Embodiment

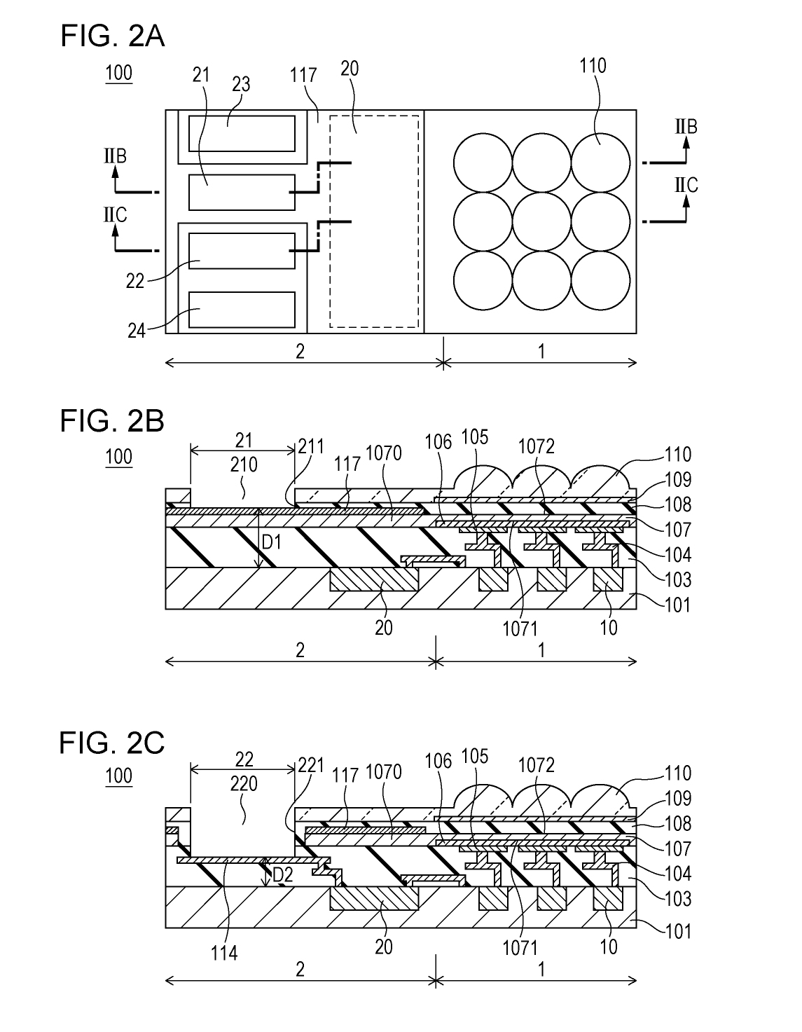

An imaging device according to a second embodiment will now be described. FIG. 2A is a schematic plan view of an imaging device 100, FIG. 2B is a schematic sectional view of the imaging device 100 taken along line IIB-IIB of FIG. 2A, and FIG. 2C is a schematic sectional view of the imaging device 100 taken along line IIC-IIC of FIG. 2A. In the second embodiment, descriptions of components similar to those in the first embodiment will be omitted.

In the second embodiment, a surface of a pad portion 21 is formed of an electroconductive film 117 that is different from an electroconductive film 1070, which is included in a common electrode portion 107, and that is in contact with a top surface 1072 of the electroconductive film 1070, which is a surface on the side opposite to pixel electrodes 105. The electroconductive film 117 is in contact with the top surface 1072, so that the connection resistance between the electroconductive film 117 and the electroconductive film 1070 can be reduced, and a good structure as a supply path through which an electric potential is supplied to the common electrode portion 107 can be obtained. In particular, in the case where the electroconductive film 1070, which is included in the common electrode portion 107, is made of a metal oxide, such as ITO, further oxidation of the electroconductive film 1070 is suppressed. Thus, the sheet resistance of the top surface 1072 of the electroconductive film 1070, which serves as a base when the electroconductive film 117 is formed, can be kept low. In contrast to this, it may be considered that the electroconductive film 117 is formed so as to be in contact not with the top surface 1072 but with a bottom surface 1071. However, in this configuration, there is a possibility that a surface of the electroconductive film 117 will be oxidized or contaminated before the common electrode portion 107 is formed. This may result in an increase in the connection resistance.

The material of the electroconductive film 117 may be, for example, a metal, such as Al, Ti, TiN, Ta, TaN, Cr, or W, or a metal compound. The electroconductive film 117 may be a single layer film or may be a multilayer film. The material of the electroconductive film 117 may be the same as the material of the surfaces of the pad portions 22, 23, and 24. By using the same material for the surface of the pad portion 21 and the surface of the pad portion 22, a connecting method, such as wire bonding, can be easily performed. In particular, by using a metal nitride, such as TiN, for the surface of the pad portion 21 and the surface of the pad portion 22, deterioration of the surface of the pad portion 21 due to natural oxidation can be suppressed.

The material of the electroconductive film 117 may be selected in such a manner that the electroconductive film 117 and a conductive member that is in contact with the surface of the pad portion 21 are connected to each other efficiently. The insulating film 108 extends from an imaging region 1 to a peripheral region 2 and has an opening 210 that defines the pad portion 21. The above-mentioned conductive member is in contact with the electroconductive film 117 via the opening 210. A side surface 211 of the opening 210 is located above the electroconductive film 117. In the second embodiment, the electroconductive film 1070, which is included in the common electrode portion 107, extends from the imaging region 1 to the peripheral region 2, and in the pad portion 21, the electroconductive film 1070, which is included in the common electrode portion 107, is present in an orthogonally-projected area of an exposed region of the electroconductive film 117. Thus, the side surface 211 of the opening 210 is also located above the electroconductive film 1070. Therefore, the pad portion 21 is formed not only of the electroconductive film 117 but also of the electroconductive film 1070, which is included in the common electrode portion 107.

The electroconductive film 117 is made of a material that allows smaller transmittance of visible light than the material of the electroconductive film 1070, so that the electroconductive film 117 can function as a light-shielding film. In the second embodiment, the electroconductive film 117 serving as a light-shielding film is disposed in such a manner as to cover the peripheral circuit unit 20. This may reduce the likelihood of malfunction of the peripheral circuit unit 20 as a result of being exposed to the visible light.

### Third Embodiment

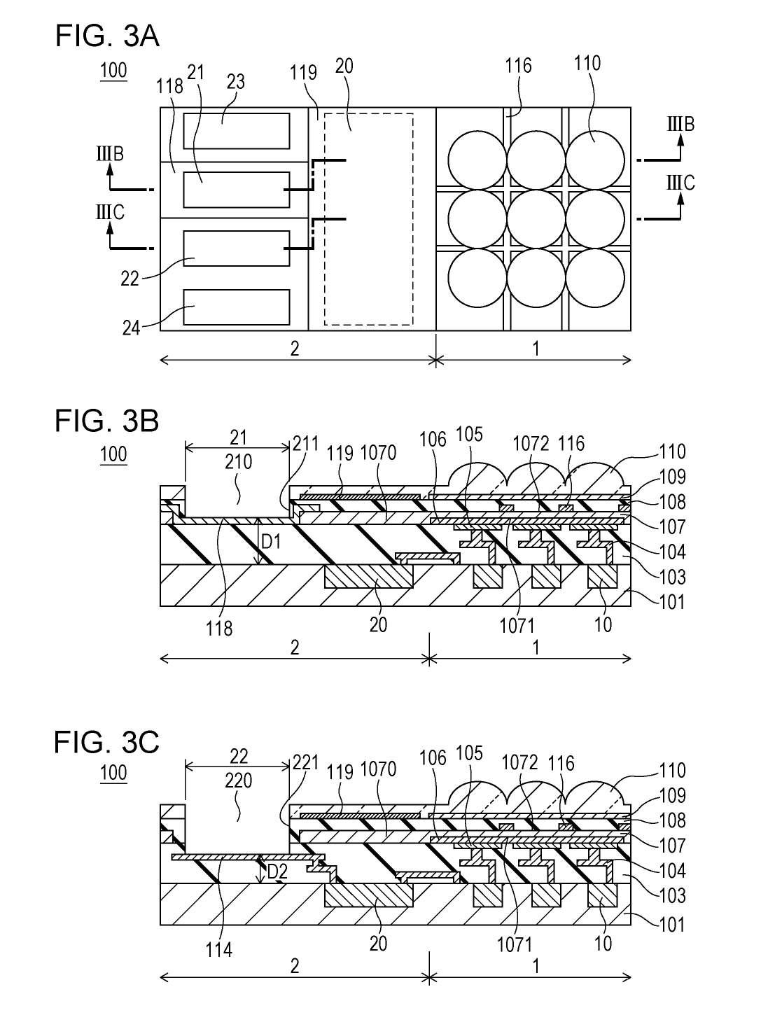

An imaging device according to a third embodiment will now be described. FIG. 3A is a schematic plan view of an imaging device 100, FIG. 3B is a schematic sectional view of the imaging device 100 taken along line IIIB-IIIB of FIG. 3A, and FIG. 3C is a schematic sectional view of the imaging device 100 taken along line IIIC-IIIC of FIG. 3A. In the third embodiment, descriptions of components similar to those in the first and second embodiments will be omitted.

In the third embodiment, a surface of a pad portion 21 is formed of an electroconductive film 118 that is in contact with a top surface 1072 of an electroconductive film 1070, which is included in a common electrode portion 107, the top surface 1072 being a surface on the side opposite to pixel electrodes 105. The pad portion 21 does not include the electroconductive film 1070, which is included in the common electrode portion 107. In the third embodiment, the electroconductive film 1070, which is included in the common electrode portion 107, extends from an imaging region 1 to a peripheral region 2 and covers a peripheral circuit unit 20. In addition, the electroconductive film 1070 is in contact with the electroconductive film 118 between a portion of the peripheral region 2 that corresponds to the peripheral circuit unit 20 and a portion of the peripheral region 2 that corresponds to the pad portion 21. However, a configuration in which the electroconductive film 1070, which is included in the common electrode portion 107, does not cover the peripheral circuit unit 20 may be employed. In this configuration, the electroconductive film 118 and the electroconductive film 1070, which is included in the common electrode portion 107, may be in contact with each other between the portion of the peripheral region 2 that corresponds to the peripheral circuit unit 20 and a portion of the imaging region 1 that corresponds to pixel circuit units 10.

The material of the electroconductive film 118 is similar to that of the electroconductive film 117 according to the second embodiment, and the material of the electroconductive film 118 may be the same as the material of the surfaces of the pad portions 22, 23, and 24. A side surface 211 of an opening 210 that defines the pad portion 21 is located above the electroconductive film 118 and is not located above the common electrode portion 107.

A light-shielding film 116 that is made of the same material as the electroconductive film 118 is disposed in the imaging region 1. The light-shielding film 116 is located above boundary portions 1061 and formed in a lattice pattern in such a manner as to have openings above photoelectric conversion portions 1060. With such a configuration, the probability of occurrence of color mixture in the imaging region 1 can be reduced. The electroconductive film 118 that extends from the peripheral region 2 to the imaging region 1 can be used as the light-shielding film 116. In this case, the electroconductive film 118 serving as the light-shielding film 116 may cover the peripheral circuit unit 20.

In the third embodiment, a light-shielding film 119 covers the peripheral circuit unit 20, and the common electrode portion 107 extends between the light-shielding film 119 and the peripheral circuit unit 20 from the imaging region 1. The light-shielding film 119 is made of, for example, a resin. In the imaging region 1, the light-shielding film 119 can be made out of the same material as a color filter 109. The light-shielding film 119 may be formed of a plurality of layers of a plurality of color filter materials stacked on top of one another or may be made of only a monochromatic color filter material, such as a blue filter material. Instead of using such a color filter material, a resin containing a black pigment or a black dye may be used for the light-shielding film 119.

Suitable modifications may be made to the above-described embodiments within the scope of the present invention. In addition, the above-described embodiments may be suitably combined. Furthermore, although the pad portions 21 to 24 are disposed in the peripheral region 2 in the above-described embodiments, the pad portions 21 to 24 may be disposed in the imaging region 1.

According to the present invention, a supply path through which an electric potential is supplied to a common electrode portion from the outside can be simplified.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-156788, filed Jul. 31, 2014, which is hereby incorporated by reference herein in its entirety.

What is claimed is:

1. An imaging device comprising:
a substrate;
a plurality of pixel electrodes;
a conductive line disposed between the substrate and the plurality of pixel electrodes;
a common electrode portion facing the plurality of pixel electrodes;
a plurality of photoelectric conversion portions each of which is disposed between a corresponding one of the plurality of pixel electrodes and the common electrode portion; and
a pad portion that is used for supplying an electric potential to the common electrode portion from outside,
wherein the pad portion includes an electroconductive film that is included in the common electrode portion.

2. The imaging device according to claim 1,
wherein an insulating film is disposed on the common electrode portion on a side opposite to the pixel electrodes,
wherein the insulating film has an opening that defines the pad portion, and
wherein a side surface of the opening is located above the electroconductive film, which is included in the common electrode portion.

3. The imaging device according to claim 1, further comprising:
an imaging region in which the plurality of pixel electrodes, the common electrode portion, and the plurality of photoelectric conversion portions are disposed; and
a peripheral region that is located outside the imaging region and in which the pad portion is disposed.

4. The imaging device according to claim 3,
wherein the substrate is a semiconductor substrate that includes a pixel circuit unit in the imaging region and a peripheral circuit unit in the peripheral region,
wherein the peripheral circuit unit and a light-shielding film that covers the peripheral circuit unit are disposed in the peripheral region, and
wherein the electroconductive film, which is included in the common electrode portion, extends between the light-shielding film and the peripheral circuit unit.

5. The imaging device according to claim 1,
wherein the substrate is a semiconductor substrate having a main surface on which a plurality of transistors are disposed,
wherein the pad portion, which is used for supplying an electric potential to the common electrode portion from the outside, is provided as a first pad portion,
wherein the imaging device further comprises a second pad portion that is used for outputting a signal from the imaging device to the outside, and
wherein a distance between the main surface of the semiconductor substrate and a surface of the first pad portion on a side opposite to the semiconductor substrate is larger than a distance between the main surface of the semiconductor substrate and a surface of the second pad portion on a side opposite to the semiconductor substrate.

6. The imaging device according to claim 1,
wherein the plurality of photoelectric conversion portions are included in a quantum dot film that continuously covers the plurality of pixel electrodes.

7. An imaging apparatus comprising:
the imaging device according to claim 1; and
a conductive member that is in contact with the pad portion.

8. An imaging system comprising:
the imaging device according to claim 1; and
a signal processing unit that processes a signal output by the imaging device.

9. An imaging device comprising:
a substrate;
a plurality of pixel electrodes;
a conductive line disposed between the substrate and the plurality of pixel electrodes;
a common electrode portion facing the plurality of pixel electrodes;
a plurality of photoelectric conversion portions each of which is disposed between a corresponding one of the plurality of pixel electrodes and the common electrode portion; and
a pad portion that is used for supplying an electric potential to the common electrode portion from outside,
wherein the pad portion includes a first electroconductive film that is different from a second electroconductive film, which is included in the common electrode portion, and the first electroconductive film is in contact with a surface of the second electroconductive film, on a side opposite to the pixel electrodes.

10. The imaging device according to claim 9,
wherein the pad portion further includes the second electroconductive film.

11. The imaging device according to claim 9,
wherein the first electroconductive film has smaller transmittance of visible light than the second electroconductive film.

12. The imaging device according to claim 9,
wherein an insulating film is disposed on the common electrode portion on a side opposite to the pixel electrodes,
wherein the insulating film has an opening that defines the pad portion, and
wherein a side surface of the opening is located above the first electroconductive film.

13. The imaging device according to claim 9, further comprising:
an imaging region in which the plurality of pixel electrodes, the common electrode portion, and the plurality of photoelectric conversion portions are disposed; and
a peripheral region that is located outside the imaging region and in which the pad portion is disposed.

14. The imaging device according to claim 13,
wherein the substrate is a semiconductor substrate that includes a pixel circuit unit in the imaging region and a peripheral circuit unit in the peripheral region,
wherein the peripheral circuit unit and a light-shielding film that covers the peripheral circuit unit are disposed in the peripheral region, and
wherein the second electroconductive film extends between the light-shielding film and the peripheral circuit unit.

15. The imaging device according to claim 9,
wherein the substrate is a semiconductor substrate having a main surface on which a plurality of transistors are disposed,
wherein the pad portion, which is used for supplying an electric potential to the common electrode portion from the outside, is provided as a first pad portion,
wherein the imaging device further comprises a second pad portion that is used for outputting a signal from the imaging device to the outside, and
wherein a distance between the main surface of the semiconductor substrate and a surface of the first pad portion on a side opposite to the semiconductor substrate is larger than a distance between the main surface of the semiconductor substrate and a surface of the second pad portion on a side opposite to the semiconductor substrate.

16. An imaging apparatus comprising:
the imaging device according to claim 9; and
a conductive member that is in contact with the pad portion.

17. An imaging system comprising:
the imaging device according to claim 9; and
a signal processing unit that processes a signal output by the imaging device.
